(19) United States
(12) Patent Application Publication
(10) Pub. No.: US 2003/0182425 A1
(43) Pub. Date: Sep. 25, 2003

(54) Communication system capable of executing a communication task in a manner adaptable to available distributed resources

(75) Inventor: Shoji Kurakake, San Francisco, CA (US)

Correspondence Address: Brinks Hofer Gilson & Lione, P.O. Box 10395, Chicago, IL, 60610, US

(73) Assignee: DoCoMo Communications Laboratories USA, Inc.

(21) Appl. No.: 10/087,487

(22) Filed: Mar. 1, 2002

(51) Int. Cl. G06F 15/16

(52) U.S. Cl. 709/226; 709/104

(57) ABSTRACT

A communication system includes a communication network, a resource-mediating server coupled with the network and one or more communication devices. The resource mediating server is configured to manage information about available resources necessary for execution of a task by the communication device. The communication device is configured for communication with the network and for executing the task using necessary resources accessed over the network, task execution being adapted in response to the information about available resources.

### BACKGROUND

The present invention relates generally to data communication networks. More particularly, the present invention relates to a communication system and method executing a communication task in a manner adaptable to available resources.

Communication systems provide access to remotely located resources. Resources are all equipment and facilities that provide services desired by a user in the system. For example, in a wireline local area network (LAN), the services of data storage and document printing might require resources of network interconnections, the user's personal computer, a disk drive and associated data storage server, and a network printer. In another example, a wireless voice communication network providing services of directory assistance for a subscriber includes as resources the subscriber's radio handset, the base station and wireline connection to a switching center, wireline connection to a centralized name and number database and the computing system implementing the database.

Sometimes there is a variety of resources available for completing a task. For example, if a user wishes to participate in a remotely-originated video conference, there may be a variety of resources available to establish a channel between the viewer and the origination point. The resources may vary by the quality of service provided. For example, one set of resources may provide full-motion, full-color video and audio. Another set of resources may provide black and white video only, reduced bandwidth or no audio.

The necessary or desired quality of service may further depend on the communication device originating the request. For example, a desktop personal computer with full color monitor and audio processing capability and coupled to a high speed data cable may be able to receive maximum quality service for a video conference. On the other hand, a palm sized personal digital assistant (PDA) or a laptop computer operating on a low bandwidth wireless link may not be able to fully receive the maximum quality transmission.

Further, necessary resources may be distributed. In the video conference example, the end user may require translation of the audio into a different language. An application on an available server may provide this service in near-real time. However, communicating the requirement from the end user, locating the resource and reserving the resource are not generally provided for in most communication networks, especially when the resources are distributed.

Accordingly, there is a need for a system and method which permit a communication device to specify a quality of service and to match the allocated resources to the desired quality of service.

### BRIEF SUMMARY

By way of introduction only, the present embodiments provide a communication system including one or more independent access networks, and one or more independent or mutually connected core networks. Each core network includes one or more resource management devices, resources managed by the resource management device, and one or more resource arbitration servers. The communication system further includes a communication device adapted for communication on each of the one or more access networks.

The foregoing discussion of the preferred embodiments has been provided only by way of introduction. Nothing in this section should be taken as a limitation on the following claims, which define the scope of the invention.

### BRIEF DESCRIPTION OF SEVERAL VIEWS OF THE DRAWINGS

FIG. 1 is a block diagram of a communication network; and

FIG. 2 shows a detailed portion of the communication network of FIG. 1.

### DETAILED DESCRIPTION OF THE PRESENTLY PREFERRED EMBODIMENTS

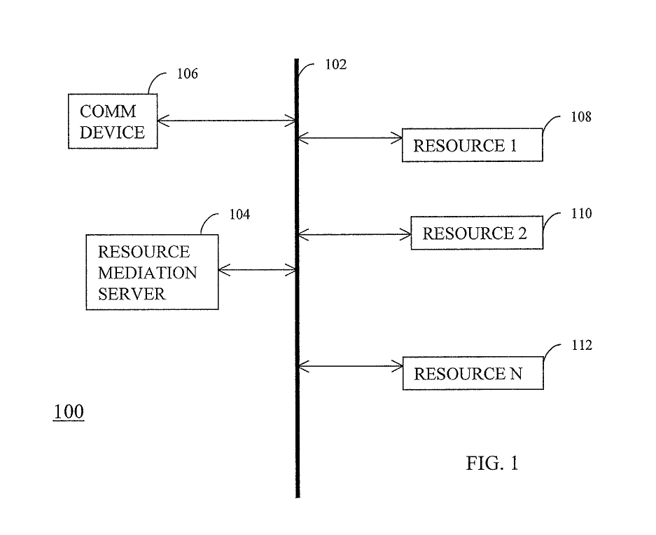

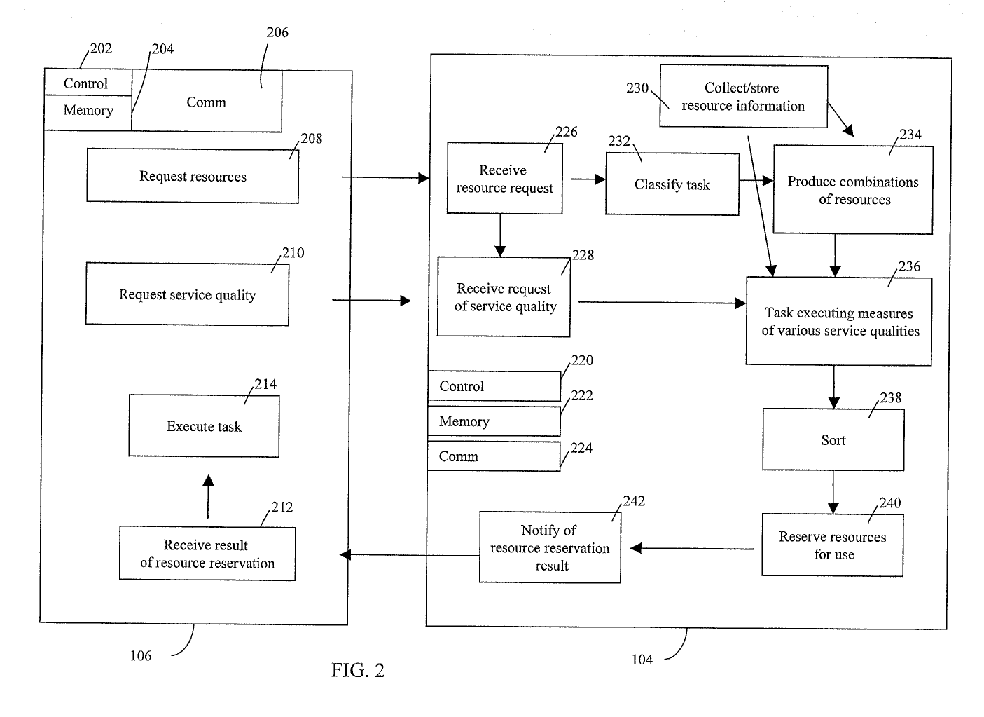

Referring now to the drawing, FIG. 1 is a block diagram of a communication system 100. The communication system 100 includes a communication network 102, a resource-mediating server 104 and one or more communication devices such as communication device 106. The resource-mediating server 104 and the communication device 106 will be described in greater detail below in conjunction with FIG. 2. In addition, the communication system 100 includes one or more resources 108, 110, 112 accessible via the network 102.

The communication network 102 provides communication among devices coupled to the network 102. The communication network 102 may use a particular technology or combination of technologies for communication, but is not limited to a single technology. The network 102 may be configured for communication of data, data representative of voice or some combination of these.

Thus, as an example, the network 102 may be a landline network using fiber optics, copper wire and local area network technology such as the Ethernet standard to provide access between the communication device 106, the resource-mediating server 104 and resources 106, 110, 112 accessible by the network 102. Further in this example, access to the network 102 from the communication device 106 may be by means of a wireless network using satellite and cellular or point to point radio technology. In another example, the network 102 may be a cellular, personal communication system (PCS) or other mobile network in which the communication device is a radiotelephone or other mobile device, communicating by radio link with a base station. The base station in turn is coupled by radio or wireline link to the network 102 and provides access to various on-line services available on the network. Some services may be free, some may require a subscription, but the services and hardware, software, permissions and licenses and other features required to access these services are all resources available on the network 102. Other examples are possible, of course, and the scope of the embodiments and their equivalents should not be limited by these exemplary embodiments.

Further, the communication network 102 may be embodied as a network of networks among which communication occurs using any available medium. For example, the network 102 may include a wireless network for communicating with the communication device 106, a fiber optic network forming an internet backbone, and a wireline local area network for accessing a selected resource 108, 110, 112. Communication among disparate networks such as these is well within the skill of those ordinarily skilled in the art of data communications.

The resource-mediating server 104 is coupled to the network 102 and configured to manage information about available resources necessary for execution of a task by another device. In particular, the resource-mediating server 104 collects, manages and acts on information about resources required by the communication device 106 for performing a communication task. The resource-mediating server 104 in one embodiment constantly exchanges information with resource provider and updates a database or other storage medium by registering resource availability, including combinations of resource devices and methods.

The communication device 106 is configured for communication with the communication network 102. This communication may be wireless or wireline or communicate by any other medium. The communication device 106 further is configured for executing a task using necessary resources over the network 102. In accordance with the present embodiments, task execution is adapted in response to the information about available resources maintained by the resource-mediating server.

The network 102 provides access to resources such as resources 108, 110, 112. The number and types of resources accessible through the network 102 are not limited in number and nature. These may include network appliances such as data storage, a printer and a processor. Further, though, these resources may be other tangible items such as software applications or data files, non-data processing equipment such as construction equipment and farm implements, and intangible resources such as intellectual property rights and licenses or financial assets. Resources are related to a task to be completed by the communication device 106.

Necessary resources are those that are required for completion of the task. Some resources may be substituted for other resources, especially if the other resources are not available. For example, if an Ethernet link is not available, providing communication at 10 Mbps, an Integrated Services Digital Network (ISDN) may be substituted with data rate of only 128 Kbps. Such a substitution may permit or require other resource substitutions as well. For example, if the slower-rate ISDN line is substituted, all other channels in the path from resource to communication device may be at the slower rate, and some data storage and buffering equipment may not be needed. Thus, available resources may be combined in any appropriate manner to fulfill the requirements of the task specified by the communication device.

When a task such as a communication task is executed by using distributed resources, the user of the communication device 106 has a certain preferred level of service quality for execution of the task. In one illustrative example, when a video teleconference is held, in one case the user may demand high quality imagine of standard television transmissions along with compact-disk quality sound. In another case, the user may be satisfied with lesser quality video and audio.

In accordance with the present embodiments, the communication device 106 sends a communication task request and also specifies a preferred level of service quality with which the communication task should be executed. Available resources, included distributed resources if necessary, are searched and reserved for use in performance of the communication task. The reserved resources are then used so that the desired communication task can be executed with the desired or specified level of service quality. In the above example, if the user of the communication device 106 specifies broadcast quality video and CD quality audio, resources necessary for communicating will be identified and reserved.

Further, according to one embodiment, based on the user's specified level of service quality, multiple task execution measures or options are provided for the user to select. In another embodiment, the multiple execution measures are ranked in order of service quality levels. This selection of the measure best meeting the service quality requirement and tradeoff of other factors, such as cost.

As used herein, the term level of service quality corresponds to the physical capabilities of the equipment and processes used in execution of a specified task. A higher service quality has a better match with the requirements of the user specifying the desired quality of service.

FIG. 2 is a block diagram of a portion of the communication system of FIG. 1. FIG. 2 shows in particular interaction of the communication device 106 and the resource-mediating server 104, both of which are shown in operational block diagram form to particularly emphasize operational aspects of these devices.

The communication device 106 includes a control device 202, a memory 204, and a communication element 206 for connecting to one or more networks such as the network 102 of the exemplary communication system 100 illustrated in FIG. 1.

Exemplary embodiments of the communication device 106 include a mobile or portable radio providing data and voice communication to a remote location; a fixed data terminal; a monitor which is associated with equipment which may or may not move and monitors some environmental, performance or other characteristic of the associated equipment, such as a device which monitors signals of the Global Positioning System and reports a geographic location of the associated equipment; a disk storage system which may actively access other data or processing resources on other networks as well as being accessed by such resources. These possible embodiments of the communication device 106 are exemplary only and should not be used to limit the scope of the embodiments described herein.

The control device 202 in one embodiment includes digital logic for implementing control functions for the communication device 106. For example, the control device 202 may include a microprocessor or microcontroller or digital signal processor. Such a processor operates in conjunction with data and instructions stored in the memory 204 to control other components of the communication device 106. In other embodiments, the control device 202 may include a user interface. Typical user interface elements include a display and keyboard or keypad as well as a microphone and speaker for audio processing.

The communication element 206 provides one-way or two-way communication with remote communication devices, such as the resource mediating server and the resources 108, 110, 112 (FIG. 1). The communication element 206 may include more than one communication means for communicating through various communication ports in various ways, such as a wireless communication card installed in a personal computer that also has an Ethernet card. The number of communication ports included with the communication device 106 is arbitrary and may vary.

The communication element 206 is embodied in any suitable form for communication with a network or another device and over the type of channel required. For example, if wireline communication over an Ethernet local area network is required, the communication element 206 may be embodied as an Ethernet card or other circuit which implements Ethernet send and receive functionality. Alternatively, if wireless communication is required, the communication element 206 may be embodied as a radio transceiver including operation at the necessary frequency bands and modulation/demodulation and encoding/decoding according to a specified standard.

The communication device 206 forms a communication circuit. The communication may be software programmable under control of the control device 202. Data or other information received from a remote source by the network communication device 206 is communicated to the appropriate destination within the communication device 106. Similarly, data or other information intended for communication to a remote destination is communicated first to the network communication device 206 for formatting, encoding, etc., according to the appropriate communication channel. Thus, the network communication device 206 may include a radio receiver and a radio transmitter for access to a wireless network or a network access card for access to a wireline network.

The remaining elements illustrated in FIG. 2 are shown in functional or operational form. The functions implemented by these elements are described in FIG. 2. These elements may be implemented as software routines executed by the control device 202 or by other logic circuitry of the communication device 104, by dedicated devices of the communication device 104, or by any other suitable means. In one embodiment, the illustrated elements are implemented as software routines by the control device 202 operating in conjunction with data and instructions stored in the memory 204. In the illustrated embodiment, the communication device 106 includes a resource requesting device 208, a service quality requesting device 210, a result receiving device 212 and a task execution device 214.

The resource requesting device 208 is configured to notify the resource-mediating server 104 of a request to use distributed resources prior to execution of a task that requires the use of such distributed resources. The request may specify specific resources, such as an Ethernet data line and switch required for communication, or may simply present a high level request or command indicating that the task is to be accomplished. In the latter case, the resource-mediating server 104 first translates or compiles the request to identify the required resources.

The service quality requesting device 210 is configured to notify the resource-mediating server of a preferred level of task service quality requested by a user of the communication device 106. The level of service quality contains information about one or more of the resources defined by the request conveyed by the resource requesting device 208. The preferred level of service quality may be specifically set out in one or more items of information. For example, the service quality requesting device 210 may specify that a video conference transmission should include audio of a first specified quality and video of a second specified quality. Alternatively, the preferred level of service quality may be implicit in the request for resources. In such an example, the request for resources might specify that receipt of a video conference is desired with the terminal or communication device 106 comprising a personal digital assistant (PDA) and the communication channel comprising a cellular telephone link to the PDA. From such a request, the resource-mediating server 104 can identify an implicit preferred level of service. In yet another example, the resource-mediating server 104 may simply detect that the request for resources was received from a cellular telephone device and adapt the quality of services provided to a suitable level.

In some embodiments, the resource requesting device 208 and the service quality requesting device 210 may be combined as a single device, application, code or code portion. The two requests may be combined into a single transmission or separated into several transmissions.

The result receiving device 212 is configured to receive a result indicating resources reserved by the resource-mediating server 104 which has been sent from the resource-mediating server 104. In one embodiment, the result merely indicates the nature of the resources the server 104 has reserved for execution of the task. In other embodiments, the result includes a list of resource options or combinations of resources, such as combinations of resources identified by the server that satisfy the preferred level of service quality.

The executing device 214 executes the specified task identified by the communication device 106. The executing device 214 may include several elements of the communication device 106, such as the communication element 206, user interface elements such as a video display and speakers, data processing elements such as the control device 202 for acting on received data, and so forth.

In an alternative embodiment, the communication device 106 includes a device for receiving a user instruction. The user instruction in this embodiment indicates whether the user uses, agrees to use or desires to use one or more reserved resources. For example, if the resource-mediating server 104 communicates a list of possible resources which may be used and have been reserved, the user of the communication device 106 may select one entry from the list. This selection may be made, for example, by operating the user interface of the communication device if one is provided, or by any other convenient method. The selection may also be made by canceling un-selected resources.

In another alternative embodiment, the communication device 106 further includes a device which notifies the resource-mediating server 104 of the user's selection of resources. Alternatively, or in addition, the device informs the resource-mediating server 104 of cancellation of un-selected resources.

The resource-mediating server 104 includes a control device 220 and a memory 222 and a communication element 226. The control device 220 controls operation of the resource arbitration server 104 and may include, for example, one or more processors operating in response to data and instructions stored in the memory 222 or received over the communication element 224.

The communication element 224 provides communication with the communication device 106 and with other devices, including devices on the communication network 102 (FIG. 1). Communication by means of the communication element 224 may be according to any suitable communication protocol, wireline or wireless. Typically, each communication will be tailored to the requirements of each particular resource being accessed by the resource-mediating server 104.

The other elements of the resource-mediating server 104 are illustrated as operational or functional blocks. These functional blocks may be implemented as applications of the control device 220, as separate logical operations or as combinations of hardware and software. These elements are illustrated as functional blocks to emphasize the functional aspects of the elements. In typical embodiments, these functional elements are embodied as control code or applications operated by the control device 220 in response to commands and data stored n the memory 222. These elements of the resource-mediating server 104 include a request receiving device 226, a service quality request receiving device 228, a resource collection device 230, a classifying device 232 and a resource combining device 234. These elements further include a varying device 236, a sorting device 238, a resource reservation device 240 and a notifying device 242.

The request receiving device 226 is configured to receive from a communication device such as the communication device 106 a request to use resources necessary for the communication device to execute a task such as a communication task. In the exemplary embodiment, the communication task is participation in a video conference. In this example, the request may specify some or all necessary details required for the video conference, such as the required bandwidth and format for communication, origin information for the video conference, etc. Alternatively, the request receiving device 226 may be required to determine some necessary details from the received request. For example, the communication channel and medium over which the request is received might specify limits or requirements for satisfaction of the request, if, for example, the request is a wireless communication via a cellular, PCS or Bluetooth transmission.

The service quality request receiving device 228 is configured to receive information from a communication device such as the communication device 106 about a preferred level of service quality for the task. The level of service quality defines details and features about the resources required for set-up and execution of the task specified in the request received by the request receiving device 226. For example, level of service quality may include information about communication bandwidth or channels or billing accounts maintained by the user of the requesting communication device.

The request receiving device 226 and the service quality request receiving device 228 may be combined into a single device, code or code portion as may be appropriate. For example, if the resource request and the service quality request are combined into a single transmission from the communication device, the transmission may be parsed by a portion of code upon receipt of the transmission in order to extract the resource request and the service quality request. The two requests may then be separately analyzed to determine their respective content and to act upon that content.

The resource collection device 230 is configured to collect and store information about resources that might be required or have been requested by the communication device 106. In one embodiment, in response to a request for resources, the resource collection device 230 locates the requested resource using any means available, including previously stored information used for satisfying previous requests, remotely stored information, queries over the network 102 (FIG. 1) or over networks such as the internet accessible from the network 102. In another embodiment, the resource collection device 230 retrieves resource information from data it has previously stored. Thus, the resource collection device 230 typically contains or is associated with a data storage medium such as a memory or a disk drive.

The classifying device 232 is configured to classify the task or application specified by the communication device 106 according to previously defined task categories. In one embodiment, the classifying device 232 conducts the classifying procedure based on a list of necessary resources received from the communication device.

The followings are examples of possible categories or classifications of tasks or applications. A first category includes (1) videoconferencing, including sub-categories of (1-2) one-to-one videoconference and (1-2) a multiple party video conference. A second category includes (2) web browsing. Within the web browsing category are sub-categories of (2-1)Web browsing at HTML browser and (2-2) web browsing at WML browser. A third category includes (3) language translation, including in this example sub-categories of (3-1) English to French, (3-2) French to English, (3-3) English to Japanese and (3-4) Japanese to English. A fourth category includes (4) media translation. This category includes subcategories of (4-1) text to speech and (4-2) voice recognition.

The resource combining device 234 produces various combinations of necessary resources required to execute the task specified by the communication device. The combinations are produced based on the task-category classification result received from the classifying device 232. The combinations include resources identified by the resource-mediating server 104 which can satisfy the request to execute a task specified by the user of the communication device. For example, if the request specifies participation in a video conference between a specified remote location and a personal computer equipped with TCP/IP address and a wireless telephone number, the resource combining device 234 will produce one combination of communication paths that includes the internet and access to the TCP/IP address, and another combination of communication paths that includes wireless access via the specified telephone number.

The following is an example of classification using the exemplary categories and sub-categories defined above. If the task specified by the communication device 106 is Web browsing at WML browser with English to French translation, the task is classified as a combination of task (2-2) and task (3-1). Then the resource combining device 234 determines that task (2-2) requires a resource capable of translation of HTML documents to WML documents such as markup language translation software running on a server connected to the network, and the task (3-1) requires a resource capable of translation of English to French such as English to French language translation software running on a server connected to the network.

The varying device 236 is configured to create variations of measures for executing the combinations of resources. The varying device 236 receives from the service quality receiving device 228 an indication of the service quality requested by the communication device. The variations reflect the service quality for which the task is executed.

Assume that the task specified by the communication device 106 requires English to French translation. A variety of resource combinations produced by the resource combining device 234 include a variety of resources which all can provide the desired English to French translation function. However the quality parameter for each resource, such as accuracy of translation results, processing speed, fee to use a service, and so forth, can be different. If an indication of the service quality requested by the communication device 106 is inexpensive but produces an translation result, the varying device 236 chooses combinations of resources that meet or almost meet the service quality indication. Then the sorting device 238 will sort the chosen combination of resources from best match to the worst.

The sorting device 238 sorts the variations created by the varying device 236 according to the task-category classification result and the service quality level requested by the communication device. The sorting device 238 may sort according to any suitable criterion. In one particular embodiment, sorting order is determined by proximity of the service quality levels for the respective combinations to the requested service quality level.

The resource reservation device 240 receives the sorting results from the sorting device 238. The resource reservation device 240 is configured to search the sorting results and reserve the resources associated with the sorting results for subsequent usage by the communication device 106. Resources are reserved in any suitable manner. For example, resources may be reserved by sending a message over the network indicating that the resource-mediating server 104 will engage the resource within a predetermined timeout period, such as five minutes. If, after elapse of the timeout period, the resource is not engaged, the resource will be released for use by another user. This prevents lock-up or removal of resources from availability in the event the communication device 106 does not actually use the reserved resources. The resource reservation device 240 produces a reservation result indicating, for example, success at reserving the reserved resources, the nature of the reserved resources, identification information for the identified resources, etc.

The notifying device 242 notifies the communication device 106 of the reservation of resources by the resource reservation device 240. The provided reservation result information may simply be an indication that the resources are available to perform the specified task, or the information may include a detailed listing of available resources, associated service quality levels and cost information. Alternatively, the information provided may include any additional information or subset of these entries available to allow the user and the communication device to execute the task.

In an alternative embodiment, the resource-mediating service 104 also includes a device for receiving a confirmation of receipt of the reservation result information from the communication device 106. The confirmation may include a specification of resources selected to be used, a cancellation of resources not selected, or any other suitable information.

In still another alternative embodiment, the resource-mediating service 104 further includes a device for acknowledging the receipt of the confirmation from communication device 106. The acknowledgement may have any suitable form.

From the foregoing, it can be seen that the present embodiments provide a method and apparatus in a communication device for specifying the distributed resources required for execution of a particular task but also for specifying a quality of service required or desired by the user of the communication device. The quality of service may be specified directly or may be implicit in the resources required. The requested quality of service is communicated with the request for resources to a server which is configured to identify available resources meeting the specified requirements. The server is further configured to form various combinations of resources to best meet the request of the user. The server determines a quality of service level provided for the combinations and selects a best combination or transmits a list of options to the communication device. In this manner, the reservation and assignment of distributed resources to a task becomes adapted to the particular requirements of the communication device. Communication devices with higher capability can enjoy a higher quality of service. Devices with more limited capabilities can select lower quality of service in order to better match their capabilities and to improve performance.

While a particular embodiment of the present invention has been shown and described, modifications may be made. It is therefore intended in the appended claims to cover all such changes and modifications which fall within the true spirit and scope of the invention.

1. A communication system comprising:
a communication network;
a resource-mediating server coupled with the network and configured to manage information about available resources necessary for execution of a task; and
a communication device configured for communication with the network and for executing a task using necessary resources accessed over the network, task execution being adapted in response to the information about available resources.

2. The communication system of claim 1 further comprising:
an agent processor coupled with the communication network and configured to receive from the communication device over the communication network control code for operating the agent processor for execution of a portion of the task.

3. The communication system of claim 1 wherein the communication device comprises:
a resource requesting device which originates a request for resources for communication to the resource-mediating server.

4. The communication system of claim 3 wherein the resource requesting device includes a list of necessary resources with the request for resources.

5. The communication system of claim 4 wherein the resource-mediating server comprises:
a classifying device configured to classify the task according to the list of necessary resources.

6. The communication system of claim 3 wherein the resource requesting device is configured to include a requested service quality level in the request for services.

7. The communication system of claim 3 further comprising:
an agent processor coupled with the communication network to receive from the communication device control code for operating the agent processor for execution of a portion of the task

8. The communication system of claim 7 wherein the communication device is configured to include a requested service quality level in the request for services and receive a service quality level offered by the agent processor in response to the requested service quality level, the communication device further being configured to adapt the control code according to the service quality level.

9. The communication system of claim 1 wherein the resource-mediating server comprises:
a device which collects resource information;
a request receiving device configured to receive a request from the communication device to use resources necessary for the communication device to execute a communication task;
a receiving device configured to receive from the communication device information defining a preferred level of service quality for the communication task;
a device which produces combinations of necessary resources satisfying the request to use resources and the preferred level of service quality; and
a notifying device configured to provide a notification of the combinations of necessary resources to the communication device.

10. The communication system of claim 9 wherein the resource-mediating server further comprises:
a sorting device which sorts the combinations of necessary resources according to service quality levels for the resources and the preferred level of service quality.

11. A communication device configured for operation in conjunction with a communication network, remote resources accessible via the network and a resource-mediating server which manages information about available resources, the communication device comprising:
an informing device which notifies a resource-mediating server of a request to use distributed resources of the communication network before execution of a task requiring the distributed resources;
a receiving device which receives from the resource-mediating server an indication of reserved resources;
a second informing device which notifies the resource-mediating server of one of a confirmation and a cancellation of reserved resources defined by the indication of reserved resources; and
a device for executing the task using the distributed resources based on the indication of reserved resources.

12. A resource-mediating server operable in conjunction with a communication network and a communication device which may execute a task using remote resources accessed over the communication network, the resource-mediating server comprising:
a device which stores resource information;
a request receiving device which receives a request from the communication device to use necessary resources for execution of the task by the communication device;
a quality request receiving device which receives information about a preferred level of service from the communication device;
a classifying device which classifies the task according to task category;
a device which produces, based on the classification of the task, combinations of necessary resources;
a device which produces measures of service quality associated with the combinations of necessary resources;
a sorting device which sorts the combinations of necessary resources based on the measures of service quality and the preferred level of service;
a reserving device which reserves resources for use by the communication device executing the task;
an informing device which notifies the communication device of the reserved resources;
a reservation receiving device which receives one of a reservation confirmation or cancellation from the communication device.

13. A method for performing a communication task in a communication device, the method comprising:
at a communication device, requesting use of distributed resources to execute a task;
requesting a preferred level of service for use of the distributed resources;
receiving an indication of reserved resources; and
executing the task using the resources of the distributed resources according to the reserved resources.

14. The method of claim 13 further comprising:
transferring information to a reserved resource for task execution by the reserved resource.
